(19) United States
(12) Patent Application Publication
(10) Pub. No.: US 2018/0373399 A1
(43) Pub. Date: Dec. 27, 2018

(54) NOTIFICATION SYSTEM FOR MOBILE DEVICE IN INTERNET-OF-THINGS (IoT) DOMAIN

(71) Applicant: QUALCOMM Incorporated, San Diego, CA (US)

(72) Inventors: Mounica BATTULA, Guwahati (IN); Ankit BANAUDHA, Hyderabad (IN); Amandeep Singh BEDI, Hyderabad (IN); Ashutosh GUPTA, Hyderabad (IN)

(21) Appl. No.: 15/629,732

(22) Filed: Jun. 21, 2017

(51) Int. Cl. G06F 3/0482; G08B 21/24

(52) U.S. Cl. CPC G06F 3/0482; H04L 51/24; G08B 21/24

(57) ABSTRACT

A method includes maintaining a notification system of a mobile device. The notification system is configured to receive a plurality of notifications generated by a plurality of applications of the mobile device. The notifications are displayed via a notification system user interface that is configured to provide a remind option for each notification. A first user input is received indicating that a user has selected the remind option for a notification, where in response thereto a device selection option is provided that displays information identifying one or more other devices on which to provide a reminder for the notification. A second user input is then received indicating that the user has selected at least one of the one or more other devices, where the mobile device then communicates with the at least one other device to configure the at least one other device to provide the reminder for the notification.

### TECHNICAL FIELD

The various aspects and embodiments described herein generally relate to telecommunications, and more particularly, but not exclusively to a notification system for a mobile device.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

As such, in the near future, increasing development in IoT technologies will lead to numerous IoT devices surrounding a user at home, in vehicles, at work, and many other locations. Due at least in part to the potentially large number of heterogeneous IoT devices and other physical objects that may be in use within a controlled IoT network, which may interact with one another and/or be used in many different ways, well-defined and reliable communication interfaces are generally needed to connect the various heterogeneous IoT devices such that the various heterogeneous IoT devices can be appropriately configured, managed, and communicate with one another to exchange information.

Furthermore, users are increasingly relying upon various IoT devices to store, track, receive, and update various types of information and handle various types of tasks. For example, many users rely upon computing devices to provide them with notifications of incoming communications, news, and other such information. Accordingly, many IoT devices, such as a smartphone include a notification system. The notification system is a combination of software and hardware that provides a means of alerting a user of the smartphone. The notification system commonly shows activity related to an account or activity related to a specific application installed on the smartphone. These reminders and notifications typically come in the form of an alert, such as an audible beep, tone, or jingle, and a visual indicator, such as a flashing light or a banner with text displayed on a display screen.

With the voluminous number of applications that are often installed on a smartphone, push messages, promotions, offers, updates and so on for each of these applications installed on a smartphone makes it difficult for the user to segregate and follow the important notifications from the not-so-important ones. For example, a notification may be generated alerting the user to an interesting news item or an editor's article, but the user might not be able to read the entire page at that time because he/she is caught up in a meeting when the headline notification popped up.

Even still, with an increasing number of diverse and multi-functional messaging applications and with the increasing number of users on each of these, it is often difficult to keep track of and to reply to all the messages received over various applications. Even still, working professionals quite generally have multiple mailboxes, but with busy work schedules, personal emails, even though important, may be ignored. For example, written replies—messages or mails—are highly prone to be neglected because, unlike phone calls—where ringing impels a user to pick calls—people are usually not organized or prompt with text replies.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to one aspect, a method includes maintaining a notification system of a mobile device. The notification system is configured to receive a plurality of notifications generated by a plurality of applications of the mobile device. The notifications are displayed via a notification system user interface that is configured to provide a remind option for each notification. A first user input is received indicating that a user has selected the remind option for a notification, where in response thereto a device selection option is provided that displays information identifying one or more other devices on which to provide a reminder for the notification. A second user input is then received indicating that the user has selected at least one of the one or more other devices, where the mobile device then communicates with the at least one other device to configure the at least one other device to provide the reminder for the notification.

According to another aspect, a mobile device includes a processor and a memory. The processor and memory are configured to direct the mobile device to: (i) maintain a notification system of the mobile device, where the notification system is configured to receive a plurality of notifications generated by a plurality of applications of the mobile device; (ii) display, by the mobile device, the plurality of notifications via a notification system user interface, where the notification system user interface is configured to provide a remind option for each of the plurality of notifications; (iii) receive, via the notification system user interface, a first user input indicating that a user has selected the remind option for one notification of the plurality of notifications; (iv) provide, by the mobile device, a device selection option via the notification system user interface in response to receiving the first user input, where providing the device selection option includes displaying information identifying one or more other devices on which to provide a reminder for the one notification; (v) receive, via the notification system user interface, a second user input indicating that the user has selected at least one of the one or more other devices; and (vi) communicate, by the mobile device, with the at least one of the one or more other devices to configure the at least one of the one or more other devices to provide the reminder for the one notification.

According to yet another aspect, a mobile device includes means for maintaining a notification system of the mobile device, where the notification system is configured to receive a plurality of notifications generated by a plurality of applications of the mobile device. The mobile device also includes a means for displaying the plurality of notifications via a notification system user interface, where the notification system user interface is configured to provide a remind option for each of the plurality of notifications. Further included in the mobile device is a means for receiving, via the notification system user interface, a first user input indicating that a user has selected the remind option for one notification of the plurality of notifications. A means for providing a device selection option is also included in the mobile device, where the device selection option is provided via the notification system user interface in response to receiving the first user input. The means for providing the device selection option includes means for displaying information identifying one or more other devices on which to provide a reminder for the one notification. The mobile device also includes a means for receiving, via the notification system user interface, a second user input indicating that the user has selected at least one of the one or more other devices, and a means for communicating with the at least one of the one or more other devices to configure the at least one of the one or more other devices to provide the reminder for the one notification.

According to a further aspect, a non-transitory computer-readable storage medium includes program code stored thereon. The program code includes instructions to direct a mobile device to: (i) maintain a notification system of the mobile device, where the notification system is configured to receive a plurality of notifications generated by a plurality of applications of the mobile device; (ii) display, by the mobile device, the plurality of notifications via a notification system user interface, where the notification system user interface is configured to provide a remind option for each of the plurality of notifications; (iii) receive, via the notification system user interface, a first user input indicating that a user has selected the remind option for one notification of the plurality of notifications; (iv) provide, by the mobile device, a device selection option via the notification system user interface in response to receiving the first user input, where providing the device selection option includes displaying information identifying one or more other devices on which to provide a reminder for the one notification; (v) receive, via the notification system user interface, a second user input indicating that the user has selected at least one of the one or more other devices; and (vi) communicate, by the mobile device, with the at least one of the one or more other devices to configure the at least one of the one or more other devices to provide the reminder for the one notification.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIGS. 1A, 1B, 1C, 1D, and 1E illustrate example high-level system architectures of wireless communications systems that may include various Internet of Things (IoT) devices, according to various aspects.

FIG. 2 illustrates an example server, according to various aspects.

FIG. 3 illustrates an example mobile device, according to various aspects.

FIG. 4 illustrates an example notification system of the mobile device of FIG. 3.

FIGS. 5A, 5B, 5C, and 5D illustrate an example notification system user interface, according to various aspects.

FIGS. 6A, 6B, and 6C illustrate an example user interface for receiving calendar event details, according to various aspects.

FIGS. 7A and 7B illustrate an example user interface for receiving alarm event details, according to various aspects.

FIG. 8 illustrates an example process of operating a notification system for a mobile device, according to various aspects.

FIG. 9 illustrates is illustrates an example mobile device represented as a series of interrelated functional modules, according to various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include mobile devices, cell phones, desktop computers, laptop computers, tablet computers, personal digital assistants (PDAs), vehicles, etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

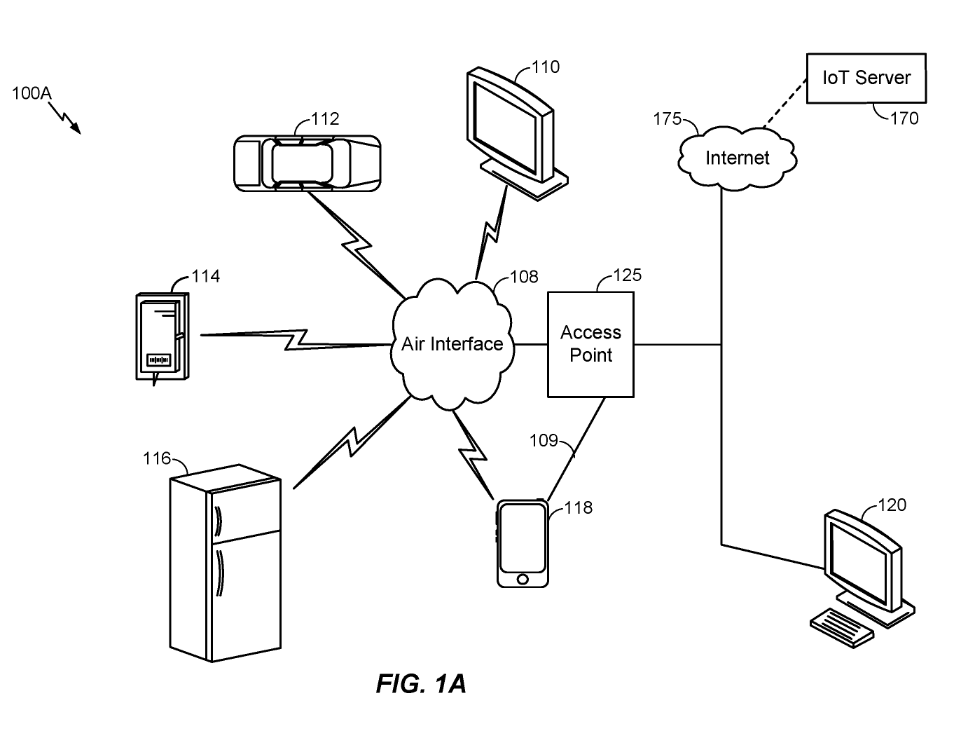

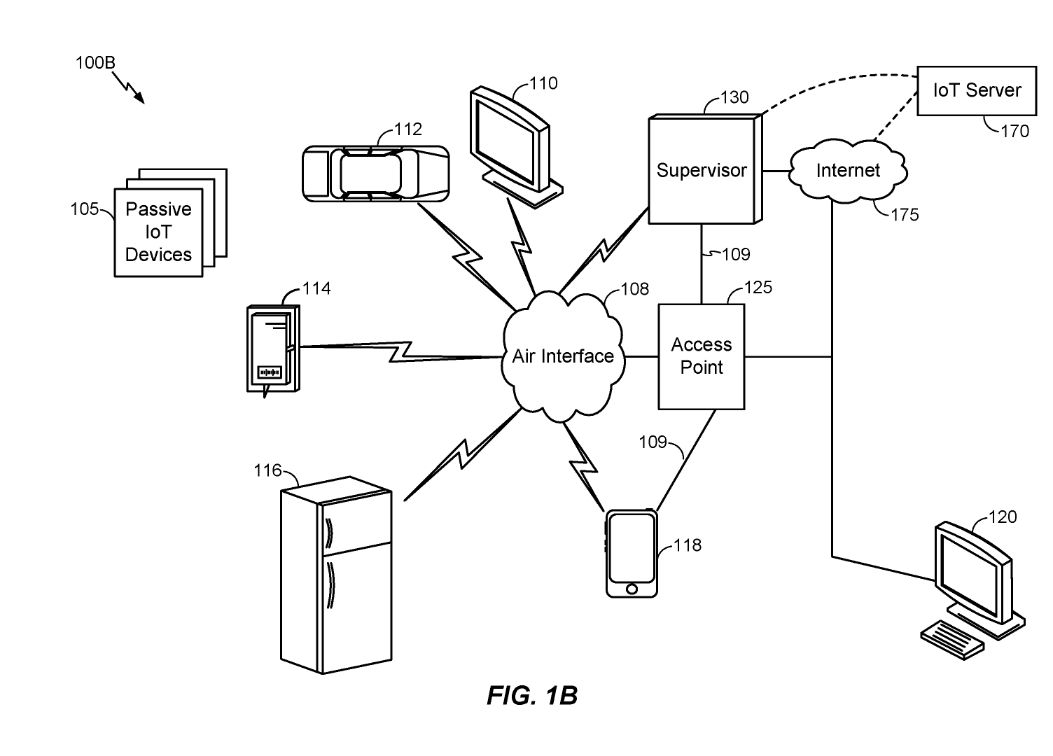

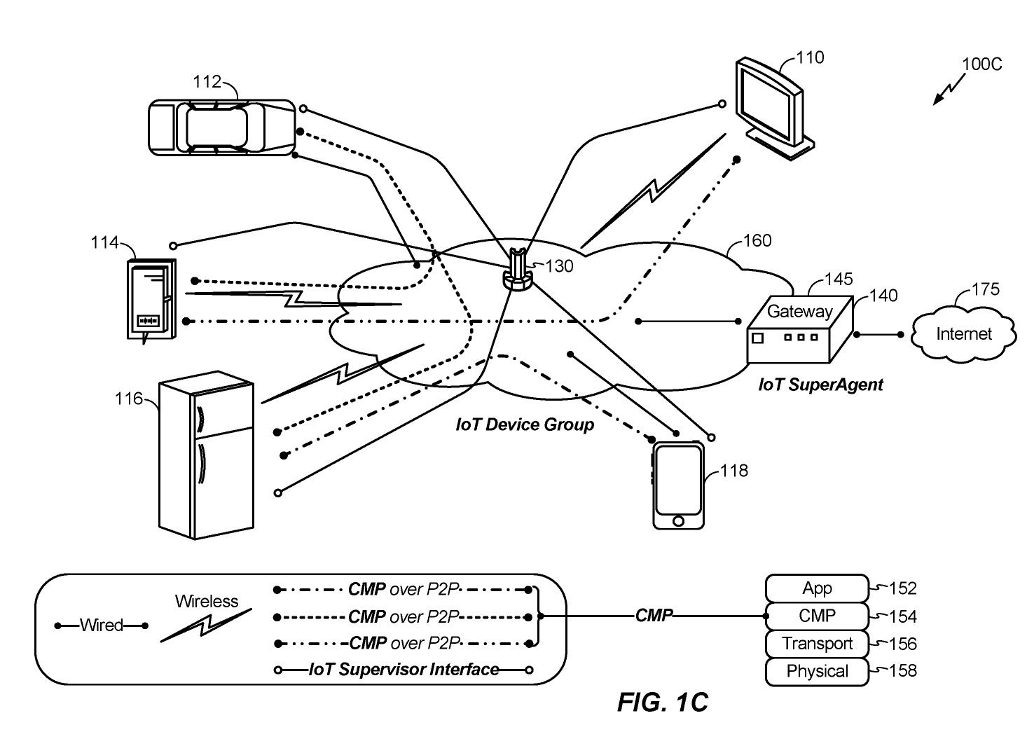

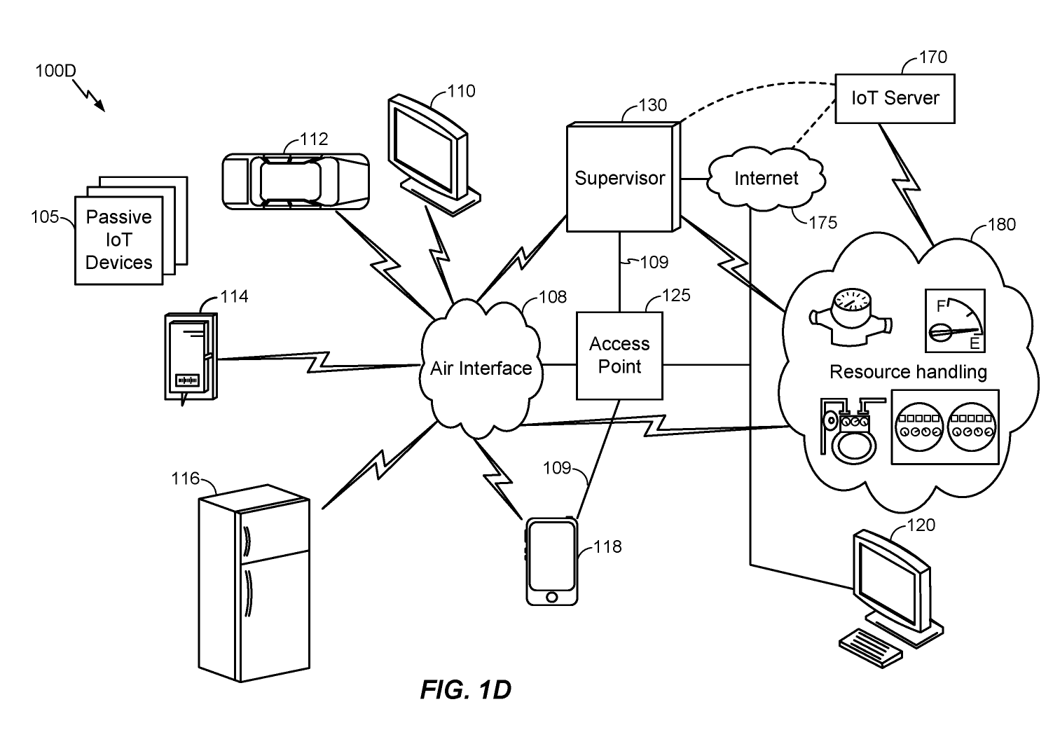

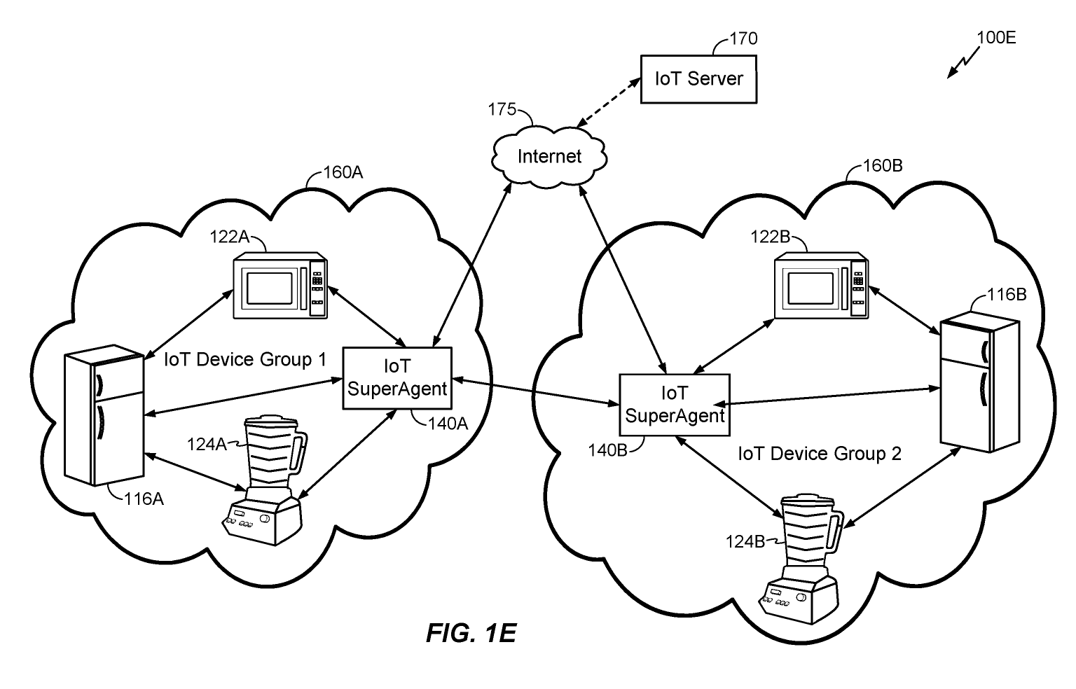

FIG. 1A illustrates a high-level system architecture of a wireless communications system 100A in accordance with various aspects. The wireless communications system 100A contains a plurality of IoT devices, which include a television 110, a vehicle 112, a thermostat 114, a refrigerator 116, and a mobile device 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the direct wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface 108. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In various embodiments, the IoT server 170 may be optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109 using appropriate device-to-device (D2D) communication technology. Alternatively, or additionally, some or all of the IoT devices 110-120 may be configured with a communication interface independent of the air interface 108 and the direct wired connection 109. For example, if the air interface 108 corresponds to a Wi-Fi interface, one or more of the IoT devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with various aspects, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, vehicle 112, thermostat 114, refrigerator 116, and mobile device 118, that are configured to communicate with an access point 125 over an air interface 108 and/or a direct wired connection 109, a computer 120 that directly connects to the Internet 175 and/or connects to the Internet 175 through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In various embodiments, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of IoT devices 110-120, such as computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide an identifier and attributes associated therewith to another device when queried over a short range interface. Active IoT devices may detect, store, communicate, act on, and/or the like, changes in attributes of passive IoT devices.

For example, the one or more passive IoT devices 105 may include a coffee cup passive IoT device 105 and an orange juice container passive IoT device 105 that each have an RFID tag or barcode. A cabinet IoT device (not shown) and the refrigerator IoT device 116 may each have an appropriate scanner or reader that can read the RFID tag or barcode to detect when the coffee cup passive IoT device 105 and/or the orange juice container passive IoT device 105 have been added or removed. In response to the cabinet IoT device detecting the removal of the coffee cup passive IoT device 105 and the refrigerator IoT device 116 detecting the removal of the orange juice container passive IoT device 105, the supervisor device 130 may receive one or more signals that relate to the activities detected at the cabinet IoT device and the refrigerator IoT device 116. The supervisor device 130 may then infer that a user is drinking orange juice from the coffee cup passive IoT device 105 and/or likes to drink orange juice from the coffee cup passive IoT device 105.

Although the foregoing describes the passive IoT devices 105 as having some form of RFID tag or barcode communication interface, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate an identity and one or more attributes associated therewith, become part of the wireless communications system 100B, and be observed, monitored, controlled, or otherwise managed with the supervisor device 130. Further, passive IoT devices 105 may be coupled to or otherwise made part of the wireless communications system 100A in FIG. 1A and observed, monitored, controlled, or otherwise managed in a substantially similar manner.

In accordance with various aspects, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The wireless communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up an IoT device group 160. The IoT device group 160 may comprise a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as computer 120 in FIG. 1A). Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, the IoT device can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with various aspects, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-100C shown in FIGS. 1A-1C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-100C illustrated in FIGS. 1A-1C, respectively.

The Internet 175 is a “resource” that can be regulated using the concept of the IoT. However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate the resource, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of a resource 180. For example, IoT devices such as a toaster, a computer, and a hairdryer may communicate with each other over a Bluetooth communication interface to regulate their use of electricity (the resource 180). As another example, IoT devices such as a desktop computer, a telephone, and a tablet computer may communicate over a Wi-Fi communication interface to regulate their access to the Internet 175 (the resource 180). As yet another example, IoT devices such as a stove, a clothes dryer, and a water heater may communicate over a Wi-Fi communication interface to regulate their use of gas. Alternatively, or additionally, each IoT device may be connected to an IoT server, such as IoT server 170, which has logic to regulate their use of the resource 180 based on information received from the IoT devices.

In accordance with various aspects, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-100D shown in FIGS. 1A-1D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-100D illustrated in FIGS. 1A-1D, respectively.

The wireless communications system 100E includes two IoT device groups 160A and 160B. Multiple IoT device groups may be connected to and/or communicate with each other via an IoT SuperAgent connected to the Internet 175. At a high level, an IoT SuperAgent may manage inter-group communications among IoT device groups. For example, in FIG. 1E, the IoT device group 160A includes IoT devices 116A, 122A, and 124A and an IoT SuperAgent 140A, while IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via IoT SuperAgents 140A and 140B, those skilled in the art will appreciate that any number of IoT device groups may suitably communicate with each other using IoT SuperAgents.

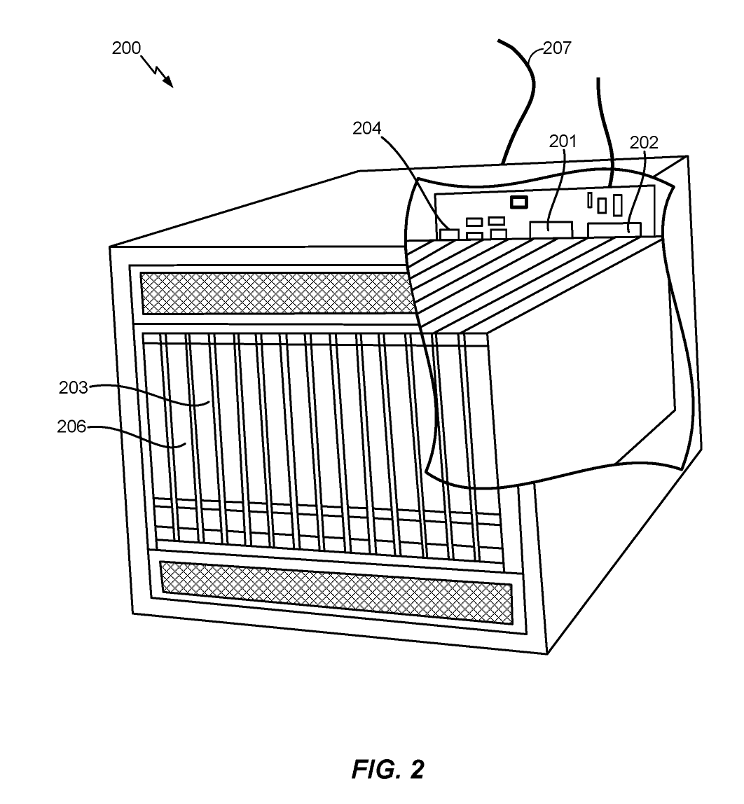

Certain aspects herein may be implemented on any of a variety of commercially available server devices, including a server 200 as illustrated in FIG. 2. In an example, the server 200 may correspond to one example configuration of the IoT server 170 described above. In FIG. 2, the server 200 includes a processor 201 coupled to volatile memory 202 and a large capacity nonvolatile memory 203 (e.g., a hard disk). The server 200 may also include a floppy disk drive, a compact disk (CD) drive, a DVD disk drive, and/or a solid-state drive 206 coupled to the processor 201. The server 200 may also include network access ports 204 coupled to the processor 201 for establishing data connections with a network 207, such as a local area network coupled to other broadcast system computers and servers or to the Internet.

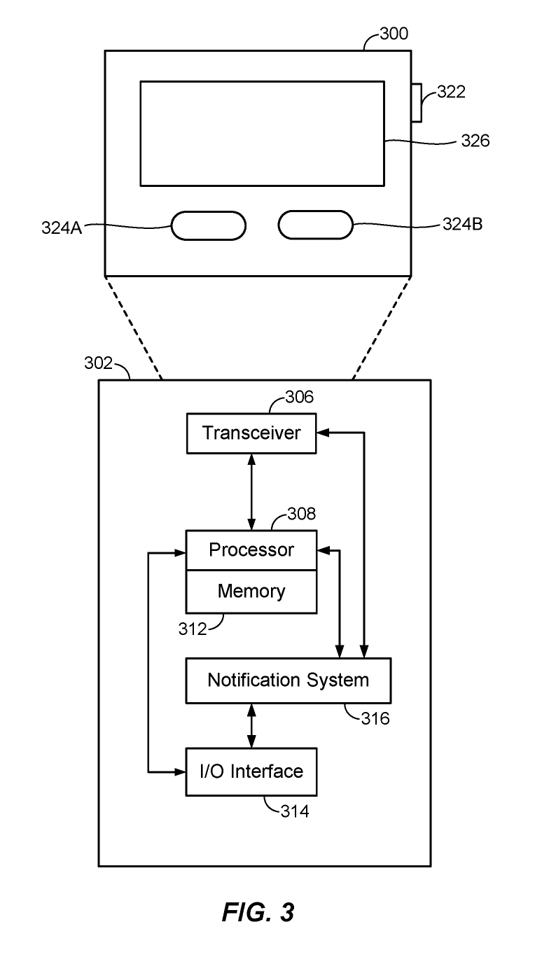

FIG. 3 illustrates an example mobile device 300, according to various aspects. FIG. 3 illustrates a high-level example of an IoT device implemented as a mobile device 300 in accordance with various aspects. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-1B.

As shown in FIG. 3, in an example configuration for the mobile device 300, an external casing of mobile device 300 may be configured with a display 326, a power button 322, and two control buttons 324A and 324B, among other components, as is known in the art. The display 326 may be a touchscreen display, in which case the control buttons 324A and 324B may not be necessary. While not shown explicitly as part of mobile device 300, the mobile device 300 may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as mobile device 300, can be embodied with different hardware configurations, a basic high-level configuration for internal hardware components is shown as platform 302 in FIG. 3. The platform 302 can receive and execute software applications, data and/or commands transmitted over a network interface, such as air interface 108 in FIGS. 1A-1B and/or a wired interface. The platform 302 can also independently execute locally stored applications. The platform 302 can include one or more transceivers 306 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 308, such as a microcontroller, microprocessor, application specific integrated circuit, digital signal processor (DSP), programmable logic circuit, or other data processing device, which will be generally referred to as processor 308. The processor 308 can execute application programming instructions within a memory 312 of the mobile device 300. The memory 312 can include one or more of read-only memory (ROM), random-access memory (RAM), electrically erasable programmable ROM (EEPROM), flash cards, or any memory common to computer platforms. One or more input/output (I/O) interfaces 314 can be configured to allow the processor 308 to communicate with and control from various I/O devices such as the display 326, power button 322, control buttons 324A and 324B as illustrated, and any other devices, such as sensors, actuators, relays, valves, switches, and the like associated with the mobile device 300.

As will be discussed in more detail below, the platform 302 of mobile device 300 may further include a notification system 316. In general, the notification system 316 is a combination of software and hardware that provides a means of alerting a user of the mobile device 300. The notification system 316 may be configured to receive a plurality of notifications generated by a plurality of applications of mobile device 300, where the notification system 316 provides a user interface that allows the user to select a remind option for each of the pending notifications. The remind option may allow the user to select from among a plurality of other IoT devices on which to receive a reminder for the selected notification.

Accordingly, various aspects can include an IoT device (e.g., mobile device 300) including the ability to perform the functions described herein. As will be appreciated by those skilled in the art, the various logic elements can be embodied in discrete elements, software modules executed on a processor (e.g., processor 308) or any combination of software and hardware to achieve the functionality disclosed herein. For example, transceiver 306, processor 308, memory 312, I/O interface 314, and notification system 316 may all be used cooperatively to load, store and execute the various functions disclosed herein and thus the logic to perform these functions may be distributed over various elements. Alternatively, the functionality could be incorporated into one discrete component. Therefore, the features of the mobile device 300 in FIG. 3 are to be considered merely illustrative and the mobile device 300 is not limited to the illustrated features or arrangement shown in FIG. 3.

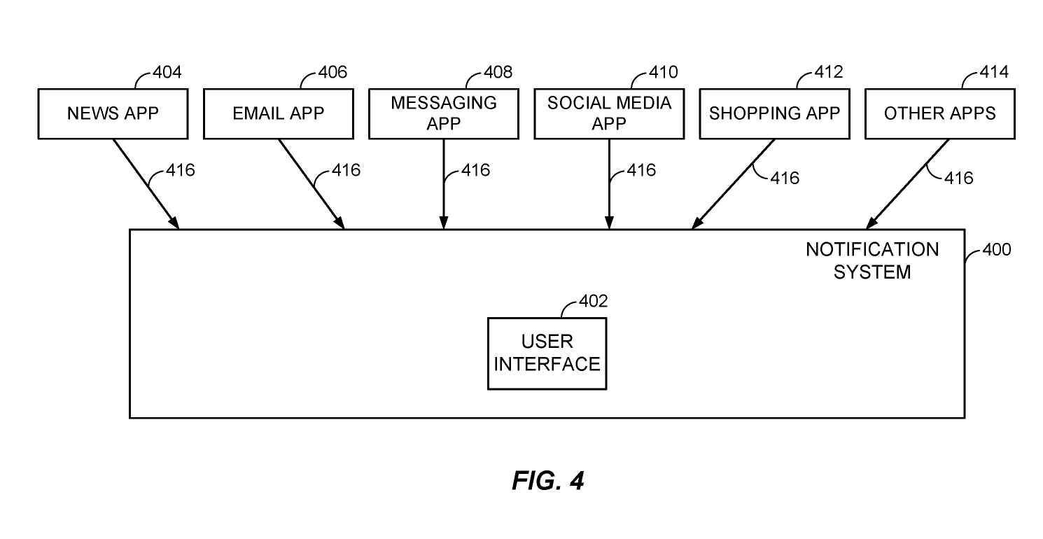

FIG. 4 illustrates an example notification system 400, according to various aspects. Notification system 400 is one possible implementation of notification system 316 of FIG. 3. As shown in FIG. 4, notification system 400 is configured to receive a plurality of notifications 416 generated by a plurality of applications 404-414. The applications 404-414 may include any application that are natively installed or user-installed on the mobile device and which are enabled to generate notifications. By way of example, FIG. 4 illustrates a news application 404, an email application 406, a messaging application 408, a social media application 410, a shopping application 412, and other applications 414. In one aspect, the notification generated by an application is specific to that application. For example, the news application 404 may generate news related notifications, such as a notification of breaking news, or of daily headlines. The email application 406 may generate email related notifications, such as a notification of a new email received at the mobile device. Similarly, the messaging application 408 may generate messaging related notifications, such as a notification of a new text message received at the mobile device. The social media application 410 may generate social media related notifications, such as a notification of a social media status update. The shopping application 412 may generate notifications related to consumer related information, such as pending sales, deals, etc. The other applications 414 may include any other application installed on the mobile device, such as a media player, media streamer, travel application, mapping application (or other location-based service application), etc.

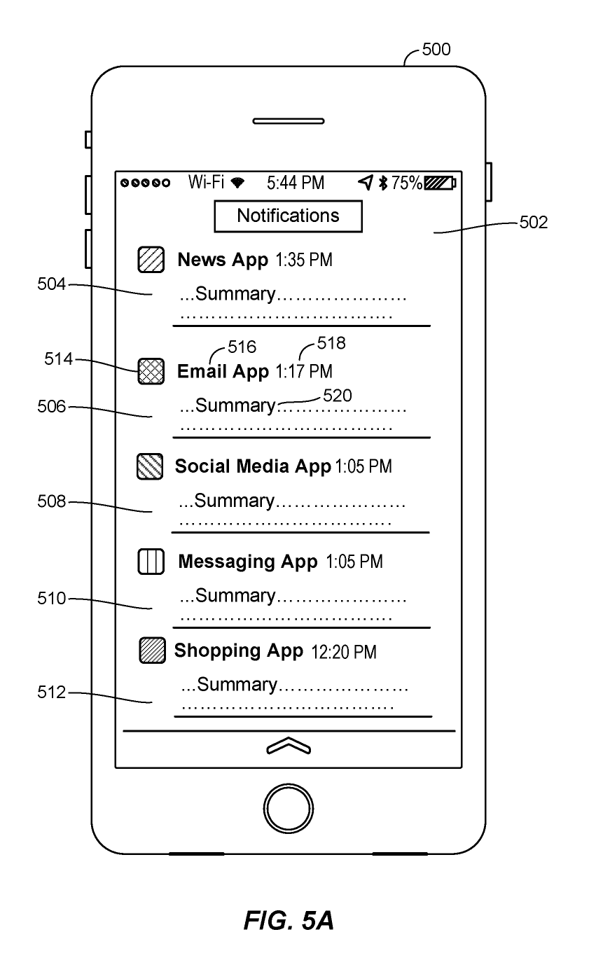

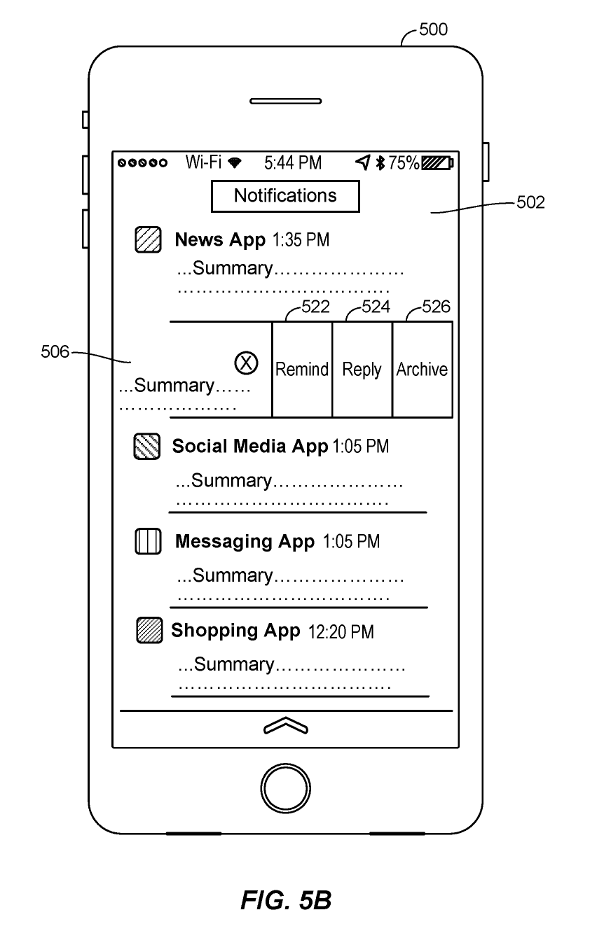

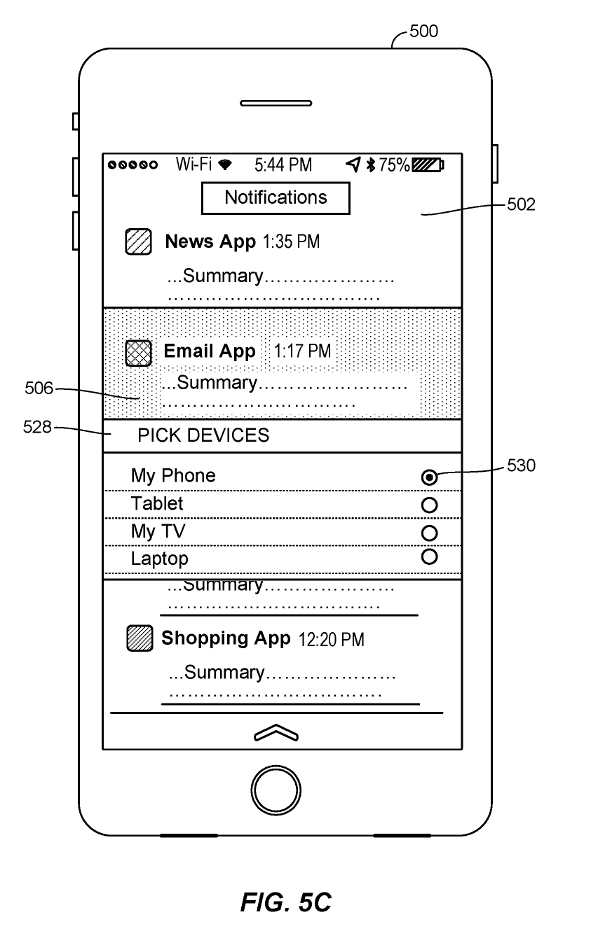

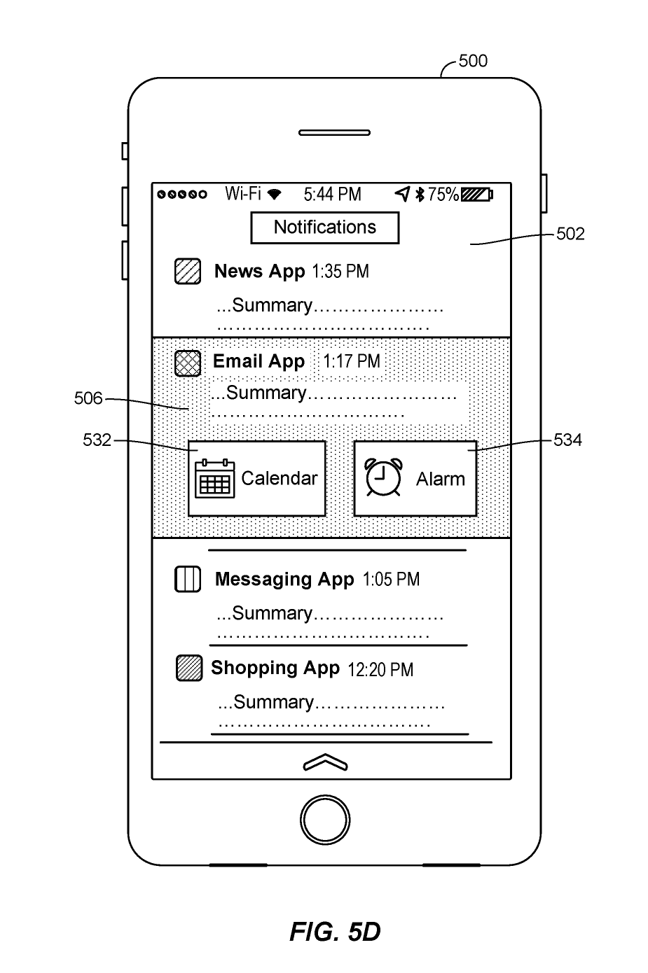

In operation, notification system 400 may receive these notifications 416 and present them to a user of the mobile device in a centralized notification system user interface 402. For example, FIG. 5A illustrates an example notification system user interface 502 that is one possible implementation of notification system user interface 402. As shown in FIG. 5A, the notification system user interface 402 is provided on a touch-screen display of mobile device 500. The example notification system user interface 502 of FIG. 5A displays several example notifications 504-512. In one aspect, the notifications 504-512 are presented in order of the date/time of that they were generated (e.g., with the most recent notification on the top). Each notification 504 may be displayed by the notification system user interface to include an icon associated with the application that generated the notification, a name of the application that generated the notification, a date/time that the notification was generated, and a brief summary of the subject of the notification. For example, notification 506 is shown as including an icon 514 associated with an email application (e.g., email application 406 of FIG. 4), a name of the email application 516, a time 518 that notification 506 was generated, and a brief summary 520 of the notification 506. In one aspect, the brief summary 520 may include an excerpt of the body and/or subject line of a new email received by the email application 406.

As mentioned above, and as illustrated in FIG. 5A, a large number of applications may be installed on a mobile device, where each application may generate numerous notifications. This large number of notifications may make it difficult for the user to segregate and follow the important notifications from the not-so-important ones. Furthermore, even if the user manages to attend to all the pending notifications, it is highly unlikely in the world of IoT that the user would want to take action on the same device on which notification is received. For example, in today's IoT world, where everything is connected, users might want to perform action for a notification on a connected device rather than the device on which notification is received. By way of example, a user may prefer shopping on a tablet rather than on a phone because debit card details are saved in some file on the tablet. In another example, a user may prefer setting an alarm for buying vegetables on a smart-fridge rather than on another device. In one example, a user may prefer replying to an email notification from laptop, not phone (e.g, so that the user may attach few documents to the email stored on his/her laptop). Further, the user may prefer playing a new song notified by Music app while travelling in his car rather than on his/her phone. Even still, a user may prefer watching a new movie trailer notified by streaming video application on a smart-TV at home. In yet another example, a user may prefer getting reminders of some important miss calls on a connected vehicle rather than via a phone while the user is driving.

Accordingly, aspects of the present disclosure provide for a notification system that provides a remind option for every notification so that a user can follow up with each of the notifications as per his/her convenience and also allow the user to choose to follow up on any connected device.

By way of example, FIG. 5B illustrates the notification system user interface 502 that provides a remind option 522 for the notification 506. In one aspect, the notification system user interface 502 is configured to display the remind option 522 for notification 506 in response to a user selecting, swiping, or otherwise interacting with notification 506. Also shown in FIG. 5B, are additional options 524 and 526. Additional options 524 and 526 may include one or more actions associated with the specific notification 506. For example, additional option 524 may include the action of replying to the email message and additional option 526 may include the action of archiving the email message. Thus, the additional options 524 and 526 may be dynamically generated options that are based on the application that generated the respective notification. Further examples of other additional options that may be presented via the notification system user interface 502 may include reply to or delete the message (e.g., for a messaging application), launch application associated with the notification (e.g., launch news application to view full news story), or to launch an application other than the one associated with the notification (e.g., shopping application may provide a notification of a pending sale, where the notification provides a web-link to launch a web browser to view the sale items on the internet).

Although, additional options 524 and 526 may be dynamically generated based on the application that generated the respective notification, the remind option 522 may be provided, according to aspects of the present disclosure, for each of the pending notifications 504-512 of the notification system user interface 502. That is, each of the notifications 504-512, when selected, may provide the remind option 522 regardless of the type of application and regardless of which particular application generated the notification.

In one aspect, the remind option 522 and the additional options 524 and 526 may be displayed on the notification system user interface 502 as virtual user interface elements, such as virtual buttons. However, in other implementations, remind option 522 and/or additional options 524 and 526 may be displayed on the notification system user interface 502 as other user interface elements such as virtual toggle buttons, steppers, pull-down menus, pickers, text fields, etc.

As discussed above, notification system user interface 502 is configured to display the remind option 522 in response to the user selecting the notification 506. The notification system user interface may then receive user input indicating that the user has selected the remind option 522 (e.g., by way of the user pressing a virtual button represented by remind option 522). In response to receiving such user input, the notification system user interface may then provide a device selection option that includes displaying information identifying one or more other devices on which to provide a reminder for the notification 506. For example, FIG. 5C illustrates a device selection option 528 that is displayed on notification system user interface 502 for notification 506. As mentioned above, the device selection option 528 is displayed in response to the user selecting the remind option 522 of FIG. 5B. In one aspect, displaying the device selection option 528 includes displaying a list of devices that may include the current mobile device 500 as well as other devices (e.g., IoT devices 110-120 of FIG. 1A).

In one aspect, the device selection option 528 may be displayed on the notification system user interface 502 as virtual user interface elements, such as virtual checkboxes 530. However, in other implementations, device selection option 528 may be displayed on the notification system user interface 502 as other user interface elements such as virtual toggle buttons, pull-down menus, pickers, text fields, etc.

In some examples, the list of devices included in the device selection option 528 includes devices that are current connected (e.g., paired) with the mobile device 500. However, the list of devices may also include one or more devices that are currently disconnected (e.g., not paired) with the mobile device 500. That is, the list of devices may include other devices that are currently in communication with the mobile device 500 as well as other devices that are not currently in communication with the mobile device 500. Thus, in one aspect, the list of devices may include other devices, with which the mobile device 500 has previously been paired with and/or that will be paired with the mobile device 500 in the future.

Furthermore, the notification system user interface 502 may be configured to filter which devices are included on the list of devices based on a known capability of the devices. That is, in some aspects not all IoT devices may be appropriate for all types of notifications (e.g., a television may not be an appropriate device for setting an email reminder). Thus, in operation, the mobile device 500 may be configured to identify a first plurality of devices that includes all connected and/or all disconnected IoT devices. The mobile device 500 may then determine a type of the selected notification (e.g., email, text messaging, video link, etc.). The mobile device 500 may then determine which of the first plurality of devices are capable of handling the type of the selected notification and filtering the first plurality of devices to generate the list of devices to include only those devices that are capable of handling the type of the notification. By way of example, referring to FIGS. 5B and 5C, in response to the user selecting the remind option for notification 506, the mobile device may first identify a first plurality of devices that includes all of the IoT devices 110-120. The mobile device 500 may then determine that a type of the notification 506 is an email-type notification. Next, the mobile device 500 determines which of the IoT devices 110-120 are capable of handling an email-type notification. In one aspect, the mobile device 500 may determine the capability of an IoT device through a capability exchange that occurs when the mobile device 500 pairs with a respective IoT device. The mobile device 500 may then filter the first plurality of devices to include only those IoT devices that are capable of handling an email-type notification. As shown in the example of FIG. 5C, the list of devices includes “My phone” (i.e., mobile device 500), “Tablet”, “My TV”, and a “Laptop”. Filtered from the first plurality of devices and thus, not included in the list of devices may be the thermostat 114, refrigerator 116, as well as other devices that the mobile device 500 determines do not have the capability to handle an email-type notification.

In one example, device selection option 528 is configured to allow the user to select no more than one device included in the list of devices (e.g., via selection of checkbox 530). However, in other examples, device selection option 528 may be configured to allow the user to select multiple devices (i.e., more than one) from the list of devices. In this example, the device selection option 528 may include a “continue” button (not shown), such that the user may select the continue button once all the desired devices have been selected.

In some aspects, once a user has selected the device or multiple devices, on which to provide a reminder for the notification, the notification system user interface 502 may be further configured to provide a reminder type option to allow the user to select the type of reminder that is to be provided. Thus, as shown in FIG. 5C, once the user has selected one or more of the devices by way of checkbox 530, the notification system user interface 502 may be configured to display the reminder type options 532 and 534 as shown in FIG. 5D. The reminder type option 532 may allow the user to enter the reminder as a calendar event on the mobile device 500, whereas the reminder type option 534 may allow the user to enter the reminder as an alarm event.

In one aspect, the reminder type options 532 and 534 may be displayed on the notification system user interface 502 as virtual user interface elements, such as virtual buttons. However, in other implementations, reminder type options 532 and 534 may be displayed on the notification system user interface 502 as other user interface elements such as virtual toggle buttons, pull-down menus, pickers, text fields, etc.

In response to the user selecting the reminder type option 532 (i.e., calendar event option), the notification system user interface 502 may then display information to allow the user to enter one or more calendar event details, such as a date for the reminder, a time for the reminder, and/or a priority for the reminder, etc. Similarly, in response to the user selecting the reminder type option 534 (i.e., alarm event option), the notification system user interface 502 may display information to allow the user to enter one or more alarm event details (e.g., date, time, priority, etc.).

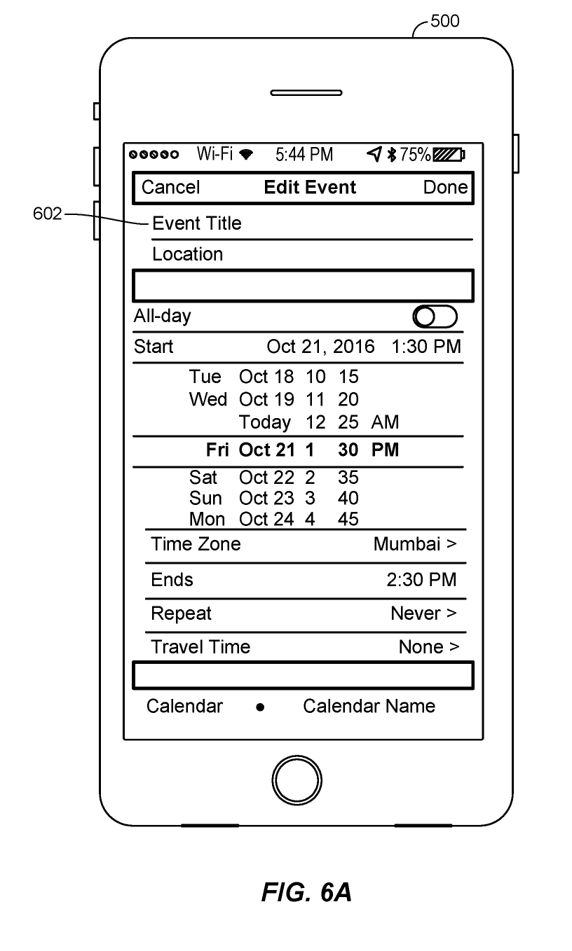

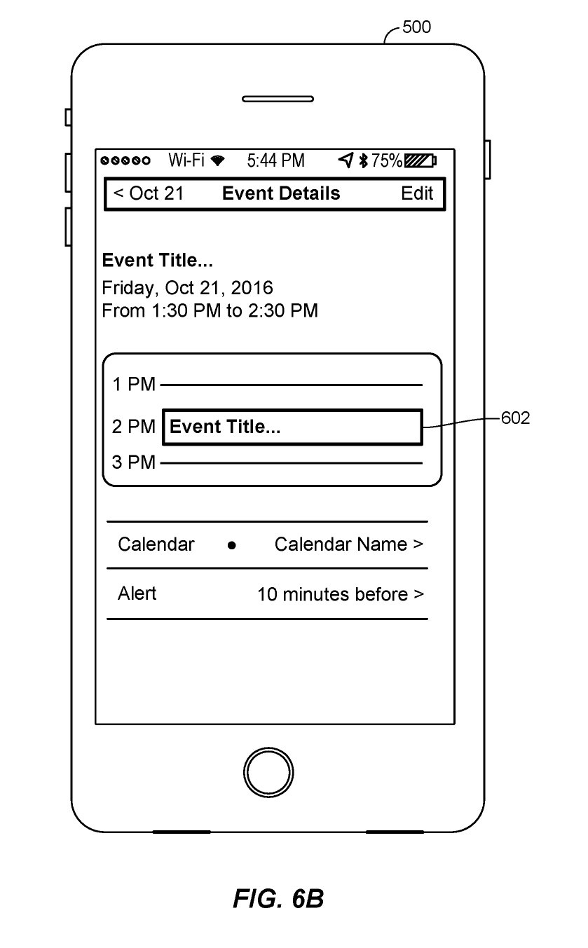

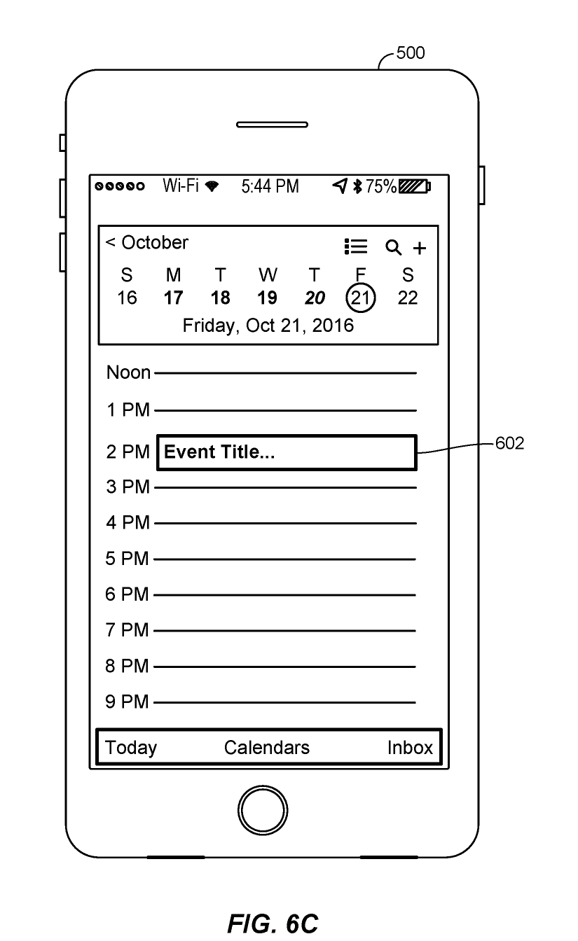

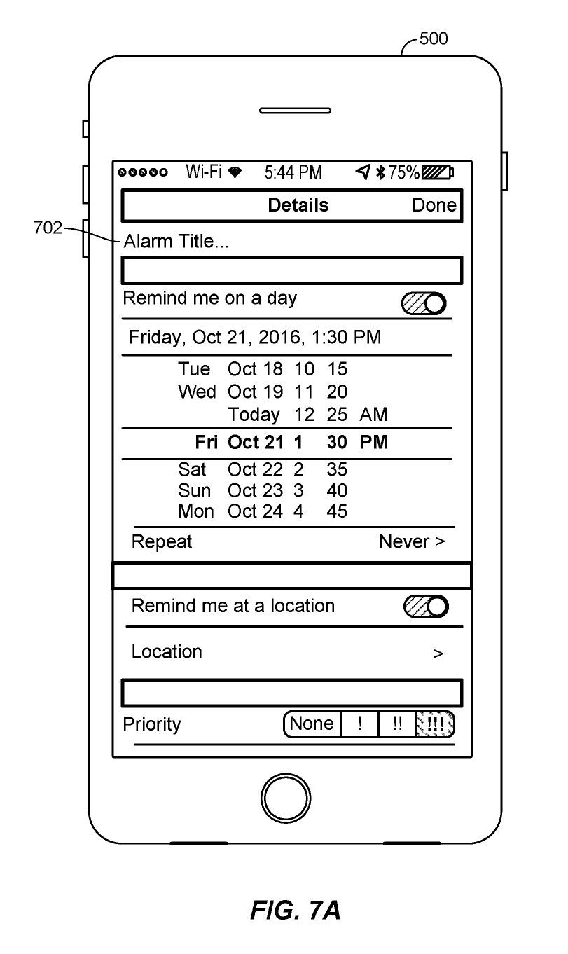

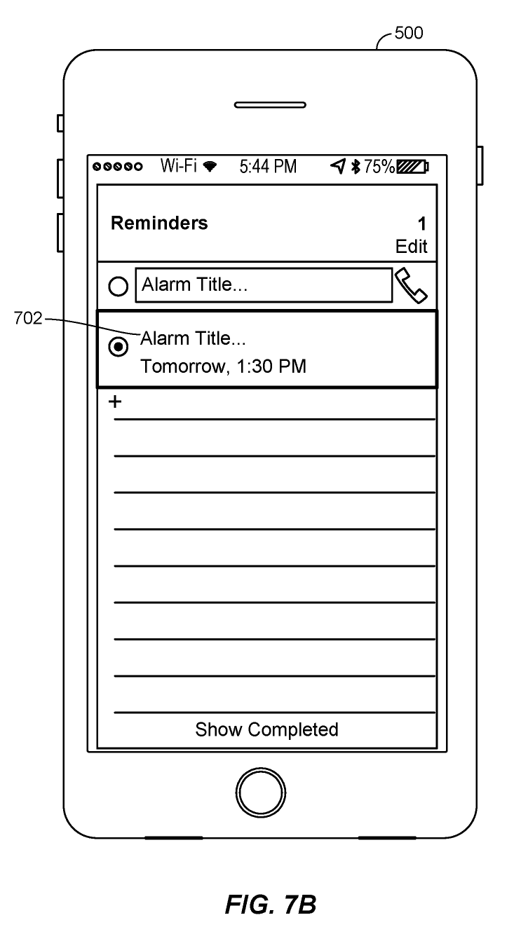

By way of example, FIGS. 6A, 6B, and 6C illustrate an example user interface for receiving calendar event details, whereas FIGS. 7A and 7B illustrate an example user interface for receiving alarm event details, according to various aspects of the present disclosure. As discussed above, the user interface of FIG. 6A may be displayed in response to the user selecting the reminder type option 532 to enter the reminder as a calendar event. Thus, FIG. 6A illustrates a user interface that is displayed on mobile device 500 to allow the user to enter one or more calendar event details, such as date, time, and or an event title 602. In one aspect, the event title may be auto-populated by the mobile device based on the notification. That is, the event title 602 may be automatically filled in to include all or part of the summary of the notification (e.g., summary 520 of FIG. 5A). Once the user has entered all the desired calendar event details via the user interface of FIG. 6A, the mobile device may provide the user interface of FIG. 6B to allow the user to enter further calendar event details, such as whether to set an alert (e.g., alert 10 minutes before). Once the user has completed entering all desired calendar event details, a calendar event is then added to a calendar maintained on mobile device 500 (e.g., see FIG. 6C).

A similar process to FIGS. 6A-6C may be employed in response to the user selecting the reminder type option 534 to enter the reminder as an alarm event. Thus, FIGS. 7A and 7B illustrate an example user interface for receiving alarm event details, according to various aspects of the present disclosure. FIG. 7A illustrates a user interface that is displayed on mobile device 500 to allow the user to enter one or more alarm event details, such as date, time, priority, and or an event title 702. In one aspect, the event title 702 may be auto-populated by the mobile device based on the notification. That is, the event title 702 may be automatically filled in to include all or part of the summary of the notification (e.g., summary 520 of FIG. 5A). Once the user has entered all the desired alarm event details via the user interface of FIG. 7A, an alarm event is then added to a list of reminders maintained on mobile device 500 (e.g., see FIG. 7B).

In operation, the mobile device 500 may be configured to monitor the calendar and reminders to determine if a calendar event and/or alarm event becomes due when the mobile device 500, itself, is selected by the user to provide a reminder for a respective notification. However, as mentioned above, the user may select one or more other devices (i.e., devices other than mobile device 500) on which to receive a reminder for a notification. Thus, in one aspect, mobile device 500 may attempt to communicate with the selected devices (i.e., those devices selected via notification system user interface 502 of FIG. 5C) to configure those devices to provide a reminder for the associated notification. In one aspect, communicating with an IoT device to configure the IoT device may include transmitting information (e.g., the notification and associated data) to one or more IoT devices over any of the wired or wireless connections described above with reference to FIGS. 1A-1D. By way of example, mobile device 500 may be configured to transfer the notification and associated data to another device in response to mobile device 500 detecting that the IoT device is connected (e.g., paired) with the mobile device 500. In response to receiving the notification and associated data, the IoT device may then provide a reminder for the notification according to the calendar event and/or alarm event details entered by the user.

For example, assume that mobile device 500 receives a notification for a live event that begins at 5:00 PM, where in response to viewing the notification, the user determines that they would prefer to receive a reminder for this notification on their television. If so, the user may select a television (i.e, an IoT device) via device selection option 528 of FIG. 5C. Further assume that the user selects to receive a reminder on the television as an alarm event by selecting the reminder type option 534 of FIG. 5D and then enters the alarm event details via the user interface shown in FIGS. 7A-7B. In this is example, the alarm event details may indicate that the event is set to begin at 5:00 PM and that an alert is to be given 10 minutes prior (i.e., 4:50 PM). Thus, the mobile device 500 may then communicate with the television any time prior to the beginning of the live event, and in one example, as soon as the mobile device 500 detects that the television is in communication with the mobile device 500, to configure the television to provide a reminder for the live event, where the reminder is provided by the television at 4:50 PM.

The above example illustrates one possible implementation of providing a reminder on another IoT device for a notification associated with a live event, where an alert is set to generate the reminder on the IoT device prior to the live event beginning. However, in other examples, the notification may be related to always available data, such as a news story, or a new download that is available (e.g., a new audio file or new video that is available for streaming and/or downloading). In this case, the IoT device may provide the reminder at the actual event time rather than at some time prior to the event time as discussed above for a live event.

In some instances, the desired IoT device may not be connected to the mobile device 500 by the time the reminder becomes due. Thus, if the mobile device 500 is unable to communicate with the desired IoT device before the reminder becomes due, the mobile device 500 may be configured to determine that communication with the IoT device was unsuccessful and, if so, the mobile device 500 may then provide an option to the user to reset the reminder. In one example, providing the option to reset the reminder may include re-generating the notification via the notification system user interface 502.

In another example, the mobile device 500 may successfully communicate the notification to the IoT device prior to the reminder becoming due, but the user may still miss the reminder given by the IoT device. In this example, the mobile device 500 may be configured to determine whether the user was located near the IoT device when the IoT device provided the reminder. In one aspect, the mobile device 500 may determine that the user was near the IoT device if the mobile device 500 is in communication (e.g., paired) with the IoT device. If the mobile device 500 determines that the user was near the IoT device when the reminder was due the mobile device 500 may determine that either the reminder was seen by the user or the user intentionally ignored the reminder, in which case the user may manually reset the notification, if so desired. If however, the mobile device 500 determines that the user was not near the IoT device when the reminder becomes due (e.g., mobile device 500 is not in communication with the IoT device when the reminder becomes due) then the mobile device 500 may determine that the reminder was missed. If so, in one example, the mobile device 500 may be configured to then provide an option to the user to reset the reminder from mobile device 500. In one example, providing the option to reset the reminder may include re-generating the notification via the notification system user interface 502.

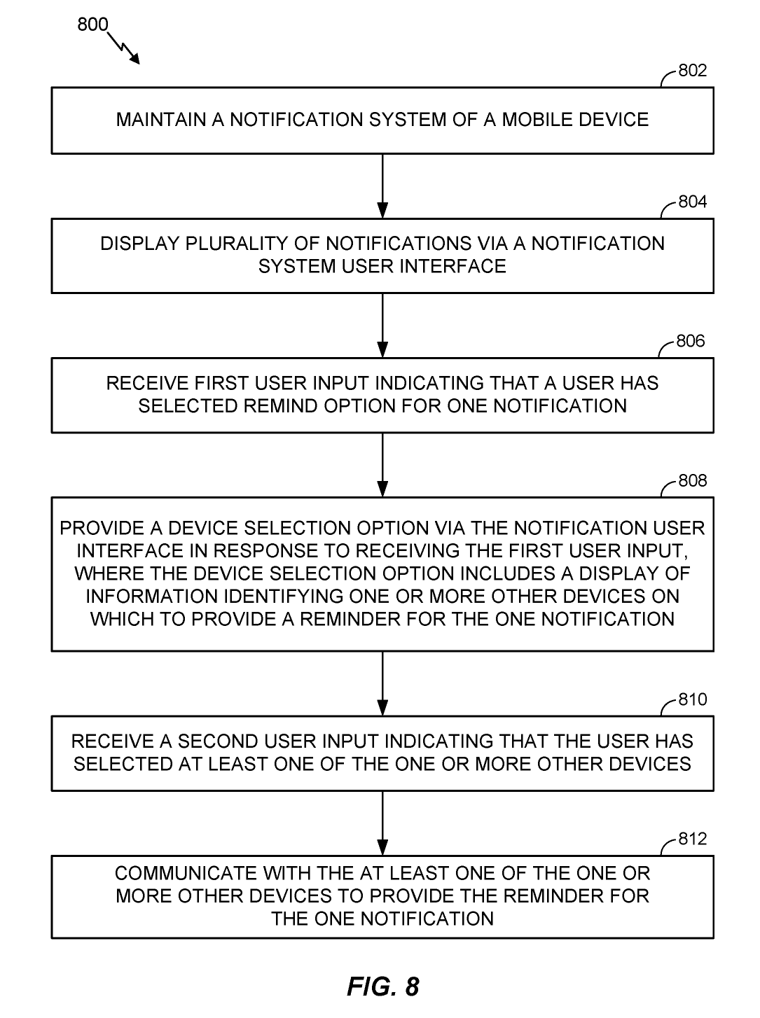

FIG. 8 illustrates an example process 800 of operating a notification system for a mobile device, according to various aspects. Process 800 is one example process that may be performed by any of the illustrated IoT devices, such as IoT devices 110-120, server 170, server 200, mobile device 300, and/or mobile device 500. In a process block 802, a notification system of a mobile device is maintained. For example, as shown in FIG. 4 a notification system 400 of mobile device 300 is provided, where the notification system 400 is configured to receive a plurality of notifications 416 generated by a plurality of applications 404-414 of the mobile device 300. In a process block 804, the mobile device displays the plurality of notifications via a notification system user interface (e.g., user interface 402 of FIG. 4 and/or user interface 502 of FIG. 5A). As described above with reference to FIG. 5B, the notification system user interface 502 is configured to provide a remind option 522 for each of the plurality of notifications. Next, process block 806 includes receiving, via the notification system user interface 502, a first user input indicating that a user has selected the remind option for one of the notifications. For example, again with reference to FIG. 5B, the notification system user interface 502 may receive first user input indicating that the user has selected the remind option 522 associated with notification 506.

In response to receiving the first user input, process block 808, includes providing a device selection option (e.g., see device selection option 528 of FIG. 5C) via the notification system user interface 502. As shown in FIG. 5C, providing the device selection option 528 includes displaying information identifying one or more other devices on which to provide a reminder for the selected notification (e.g., notification 506 of FIG. 5C). Next, in process block 810, a second user input is received via the notification system user interface 502, where the second user input indicates that the user has selected at least one of the one or more other devices shown in the device selection option 528. In process block 812, the mobile device 500 then communicates with the selected device(s) to configure the selected device(s) to provide the reminder for the selected notification.

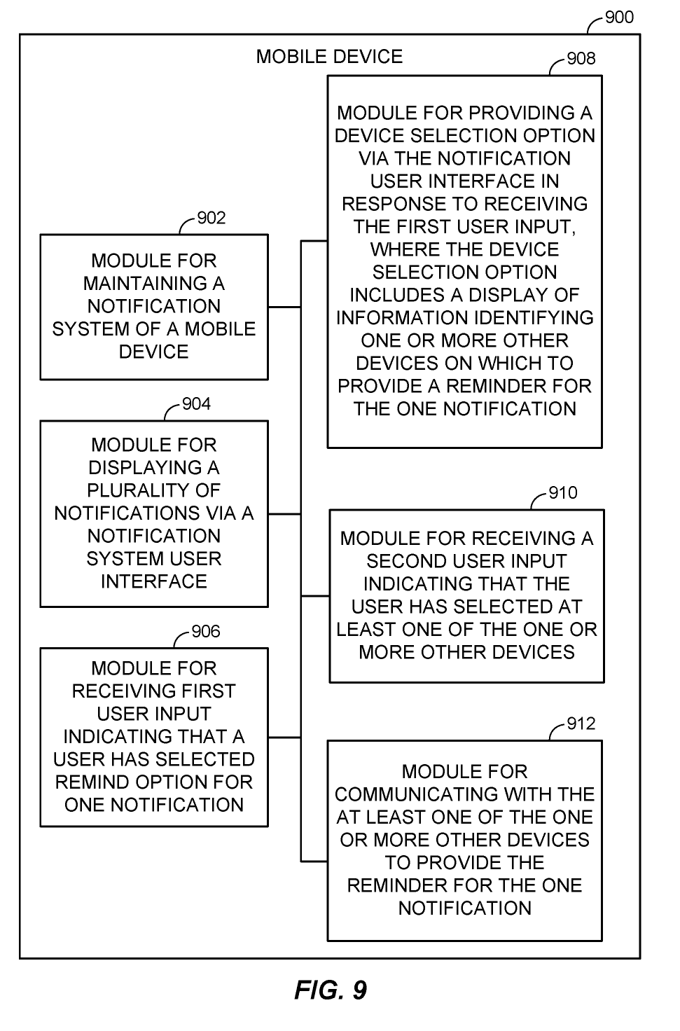

FIG. 9 illustrates is illustrates an example mobile device 900 represented as a series of interrelated functional modules, according to various aspects. A module 902 for maintaining a notification system of a mobile device may correspond at least in some aspects to, for example, processor 308, memory 312 and/or notification system 316 as discussed above with reference to FIG. 3. A module 904 for displaying a plurality of notifications via a notification system user interface may correspond at least in some aspects to, for example, processor 308, memory 312, notification system 316, of FIG. 3, user interface 402 of FIG. 4, and/or notification system user interface 502 of FIG. 5A. A module 906 for receiving first user input indicating that the user has selected a remind option for one notification may correspond at least in some aspects to, for example, processor 308, memory 312, I/O interface 314, notification system 316, of FIG. 3, user interface 402 of FIG. 4, and/or notification system user interface 502 of FIGS. 5A and 5B. A module 908 for providing a device selection option via the notification system user interface in response to receiving the first user input may correspond at least in some aspects to, for example, processor 308, memory 312, notification system 316 of FIG. 3, user interface 402 of FIG. 4, and/or notification system user interface 502 of FIG. 5C. A module 910 for receiving a second user input indicating that the user has selected at least one of the one or more other devices may correspond at least in some aspects to, for example, processor 308, memory 312, I/O interface 314, notification system 316 of FIG. 3, user interface 402 of FIG. 4, and/or notification system user interface 502 of FIG. 5C. A module 912 for communicating with the at least one of the one or more other devices to provide the reminder for the one notification may correspond at least in some aspects to, for example, transceiver 306, processor 308, memory 312, and/or notification system 316 of FIG. 3.

The functionality of the modules of FIG. 9 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 9, as well as other components and functions described herein, may be implemented using any suitable means. Such means also may be implemented, at least in part, using corresponding structure as taught herein. For example, the components described above in conjunction with the “module for” components of FIG. 9 also may correspond to similarly designated “means for” functionality. Thus, in some aspects one or more of such means may be implemented using one or more of processor components, integrated circuits, or other suitable structure as taught herein.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. The functions, steps and/or actions of the method claims in accordance with the aspects and embodiments described herein need not be performed in any particular order. Furthermore, although elements may be described above or claimed in the singular, the plural is contemplated unless limitation to the singular is explicitly stated.

What is claimed is:

1. A method, comprising:
maintaining a notification system of a mobile device, wherein the notification system is configured to receive a plurality of notifications generated by a plurality of applications of the mobile device;
displaying, by the mobile device, the plurality of notifications via a notification system user interface, wherein the notification system user interface is configured to provide a remind option for each of the plurality of notifications;
receiving, via the notification system user interface, a first user input indicating that a user has selected the remind option for one notification of the plurality of notifications;
providing, by the mobile device, a device selection option via the notification system user interface in response to receiving the first user input, wherein providing the device selection option includes displaying information identifying one or more other devices on which to provide a reminder for the one notification;
receiving, via the notification system user interface, a second user input indicating that the user has selected at least one of the one or more other devices; and
communicating, by the mobile device, with the at least one of the one or more other devices to configure the at least one of the one or more other devices to provide the reminder for the one notification.

2. The method of claim 1, wherein providing the remind option comprises displaying the remind option via the notification system user interface in response to the user selecting the one notification.

3. The method of claim 2, further comprising displaying at least one additional option for the one notification in response to the user selecting the one notification, wherein the at least one additional option comprises an action associated with the one notification.

4. The method of claim 2, wherein the action associated with the one notification comprises an action selected from the group consisting of: reply to email, reply to message, archive email, delete message, launch application associated with the one notification, and launch another application other than the application associated with the one notification.

5. The method of claim 1, further comprising:
providing, by the mobile device, a reminder type option via the notification system user interface in response to receiving the second user input.

6. The method of claim 5, wherein providing the reminder type option comprises displaying a first reminder type to enter the reminder as a calendar event and a second reminder type to enter the reminder as an alarm event.

7. The method of claim 6, further comprising receiving user input indicating at least one calendar event or alarm event details.

8. The method of claim 7, wherein the calendar event and alarm event details comprise at least one detail selected from the group consisting of: a date for the reminder, a time for the reminder, and a priority of the reminder.

9. The method of claim 1, wherein displaying information identifying one or more other devices on which to provide the reminder for the one notification comprises displaying a list of the one or more other devices via the notification system user interface.

10. The method of claim 9, wherein the list of the one or more other devices includes at least one device that is currently connected to the mobile device and at least one device that is currently disconnected from the mobile device.

11. The method of claim 9, further comprising:
identifying a first plurality of other devices;
determining a type of the one notification;
determining which of the first plurality of other devices are capable of handling the type of the one notification; and
filtering the first plurality of other devices to generate the list of one or more other devices to include only those other devices that are capable of handling the type of the one notification.

12. The method of claim 1, wherein communicating with the at least one of the one or more other devices to configure the at least one of the one or more other devices to provide the reminder for the one notification comprises:
attempting to communicate with the at least one of the one or more other devices in response to the reminder becoming due;
determining that communication with the at least one of the one or more other devices was unsuccessful; and if so,
providing an option to the user to reset the reminder.

13. A mobile device, comprising:
a processor; and
a memory coupled to the processor, wherein the processor and the memory are configured to direct the mobile device to:
maintain a notification system of the mobile device, wherein the notification system is configured to receive a plurality of notifications generated by a plurality of applications of the mobile device;
display, by the mobile device, the plurality of notifications via a notification system user interface, wherein the notification system user interface is configured to provide a remind option for each of the plurality of notifications;
receive, via the notification system user interface, a first user input indicating that a user has selected the remind option for one notification of the plurality of notifications;
provide, by the mobile device, a device selection option via the notification system user interface in response to receiving the first user input, wherein providing the device selection option includes displaying information identifying one or more other devices on which to provide a reminder for the one notification;
receive, via the notification system user interface, a second user input indicating that the user has selected at least one of the one or more other devices; and
communicate, by the mobile device, with the at least one of the one or more other devices to configure the at least one of the one or more other devices to provide the reminder for the one notification.

14. The mobile device of claim 13, wherein the processor and the memory are configured to direct the mobile device to:
provide, by the mobile device, a reminder type option via the notification system user interface in response to receiving the second user input.

15. The mobile device of claim 14, wherein the processor and the memory are configured to direct the mobile device to:
display a first reminder type to enter the reminder as a calendar event and a second reminder type to enter the reminder as an alarm event.

16. The mobile device of claim 15, wherein the processor and the memory are configured to direct the mobile device to:
receive user input indicating at least one calendar event or alarm event details.

17. The mobile device of claim 16, wherein the calendar event and alarm event details comprise at least one detail selected from the group consisting of: a date for the reminder, a time for the reminder, and a priority of the reminder.

18. The mobile device of claim 13, wherein displaying information identifying one or more other devices on which to provide the reminder for the one notification comprises displaying a list of the one or more other devices via the notification system user interface.

19. The mobile device of claim 18, wherein the list of the one or more other devices includes at least one device that is currently connected to the mobile device and at least one device that is currently disconnected from the mobile device.

20. The mobile device of claim 18, wherein the processor and the memory are configured to direct the mobile device to:
identify a first plurality of other devices;
determine a type of the one notification;
determine which of the first plurality of other devices are capable of handling the type of the one notification; and
filter the first plurality of other devices to generate the list of one or more other devices to include only those other devices that are capable of handling the type of the one notification.

21. The mobile device of claim 13, wherein the processor and the memory are configured to direct the mobile device to:
attempt to communicate with the at least one of the one or more other devices in response to the reminder becoming due;
determine that communication with the at least one of the one or more other devices was unsuccessful; and if so,
provide an option to the user to reset the reminder.

22. A mobile device, comprising:
means for maintaining a notification system of the mobile device, wherein the notification system is configured to receive a plurality of notifications generated by a plurality of applications of the mobile device;
means for displaying, by the mobile device, the plurality of notifications via a notification system user interface, wherein the notification system user interface is configured to provide a remind option for each of the plurality of notifications;
means for receiving, via the notification system user interface, a first user input indicating that a user has selected the remind option for one notification of the plurality of notifications;
means for providing, by the mobile device, a device selection option via the notification system user interface in response to receiving the first user input, wherein the means for providing the device selection option includes means for displaying information identifying one or more other devices on which to provide a reminder for the one notification;
means for receiving, via the notification system user interface, a second user input indicating that the user has selected at least one of the one or more other devices; and
means for communicating, by the mobile device, with the at least one of the one or more other devices to configure the at least one of the one or more other devices to provide the reminder for the one notification.

23. The mobile device of claim 22, further comprising:
means for providing, by the mobile device, a reminder type option via the notification system user interface in response to receiving the second user input.

24. The mobile device of claim 23, wherein the means for providing the reminder type option comprises means for displaying a first reminder type to enter the reminder as a calendar event and a second reminder type to enter the reminder as an alarm event.

25. The mobile device of claim 24, further comprising means for receiving user input indicating at least one calendar event or alarm event details, wherein the calendar event and alarm event details comprise at least one detail selected from the group consisting of: a date for the reminder, a time for the reminder, and a priority of the reminder.

26. The mobile device of claim 22, wherein the means for displaying information identifying one or more other devices on which to provide the reminder for the one notification comprises means for displaying a list of the one or more other devices via the notification system user interface, wherein the list of the one or more other devices includes at least one device that is currently connected to the mobile device and at least one device that is currently disconnected from the mobile device.

27. The mobile device of claim 26, further comprising:
means for identifying a first plurality of other devices;
means for determining a type of the one notification;
means for determining which of the first plurality of other devices are capable of handling the type of the one notification; and
means for filtering the first plurality of other devices to generate the list of one or more other devices to include only those other devices that are capable of handling the type of the one notification.

28. The mobile device of claim 22, wherein the means for communicating with the at least one of the one or more other devices to configure the at least one of the one or more other devices to provide the reminder for the one notification comprises:
means for attempting to communicate with the at least one of the one or more other devices in response to the reminder becoming due;
means for determining that communication with the at least one of the one or more other devices was unsuccessful; and if so,
means for providing an option to the user to reset the reminder.

29. A non-transitory computer-readable storage medium including program code stored thereon, the program code comprising instructions to direct a mobile device to:
maintain a notification system of the mobile device, wherein the notification system is configured to receive a plurality of notifications generated by a plurality of applications of the mobile device;
display, by the mobile device, the plurality of notifications via a notification system user interface, wherein the notification system user interface is configured to provide a remind option for each of the plurality of notifications;
receive, via the notification system user interface, a first user input indicating that a user has selected the remind option for one notification of the plurality of notifications;
provide, by the mobile device, a device selection option via the notification system user interface in response to receiving the first user input, wherein providing the device selection option includes displaying information identifying one or more other devices on which to provide a reminder for the one notification;
receive, via the notification system user interface, a second user input indicating that the user has selected at least one of the one or more other devices; and
communicate, by the mobile device, with the at least one of the one or more other devices to configure the at least one of the one or more other devices to provide the reminder for the one notification.

30. The non-transitory computer-readable storage medium of claim 29, wherein the program code further comprises instructions to direct the mobile device to:
provide a reminder type option via the notification system user interface in response to receiving the second user input, wherein the instructions to provide the reminder type option comprises instructions to display a first reminder type to enter the reminder as a calendar event and a second reminder type to enter the reminder as an alarm event.
